(19) United States
(12) Patent Application Publication
(10) Pub. No.: US 2013/0105308 A1
(43) Pub. Date: May 2, 2013

(54) MINIATURE REFERENCE ELECTRODE

(71) Applicants: Angel Zhivkov Kirchev, Aix-les-Bains (FR); Bernard Diem, Echirolles (FR); Florence Mattera, Sarcenas (FR)

(72) Inventors: Angel Zhivkov Kirchev, Aix-les-Bains (FR); Bernard Diem, Echirolles (FR); Florence Mattera, Sarcenas (FR)

(21) Appl. No.: 13/809,831

(22) PCT Filed: Jul. 12, 2011
(86) PCT No.: PCT/FR11/00416

§ 371 Date: Jan. 11, 2013

(30) Foreign Application Priority Data
Jul. 16, 2010 (FR) 1003007

(51) Int. Cl. G01N 27/30

(52) U.S. Cl. CPC G01N 27/301
USPC 204/282; 427/58

(57) ABSTRACT

A reference electrode includes a reference electrolyte and a proton exchange membrane arranged to separate the reference electrolyte from a medium external to the electrode. The proton-exchange membrane comprises acid-doped polyaniline. The acid-doped polyaniline is in the form of particles distributed in a bonding polymer material.

### BACKGROUND OF THE INVENTION

The present disclosure relates to a miniature reference electrode for measuring potentials in electrochemical systems.

### STATE OF THE ART

Reference electrodes are mainly used to measure electrode potentials in electrochemical systems. Typically, the potential of a work electrode in an electrochemical cell is defined with respect to the reference electrode, by measuring the voltage between the work electrode and the reference electrode.

The reference electrode mainly comprises a couple of redox materials having a constant potential and an internal electrolyte. The silver/silver chloride couple (Ag/AgCl) is widely used on account of its high stability and of its reversibility of reaction. In this type of electrode, the electrolyte is a solution is saturated with potassium chloride (KCl) or with sodium chloride (NaCl). The electrode potential varying according to the concentration of chloride ions contained in the electrolyte, said concentration should be as stable as possible.

A porous membrane, called liquid junction, is conventionally used to separate the internal electrolyte from the cell electrolyte. Such a membrane allows an exchange of protons (H⁺) between the two electrolytes. It slows down the diffusion of ions (K⁺, Na⁺, Cl⁻ . . . ) between the cell and the reference electrode, to maintain a constant reference potential.

Recently, the dimensions of electrochemical systems such as chemical sensors and batteries have considerably decreased. An effort is made to miniaturize reference electrodes and thus ease their integration in such systems. Now, miniaturization also implies a significant decrease of the internal electrolyte volume. The phenomenon of modification of the electrolyte concentration and/or composition is thus enhanced.

FIG. 1 shows an exploded view of a miniature reference electrode such as described in patent U.S. Pat. No. 6,419,809.

This electrode is formed of thin layers successively deposited on a glass substrate 2. The electrode comprises a silver layer 4 having a portion 4′ turned into silver chloride AgCl. Portion 4′ is in contact with an electrolyte layer 6 through a slot 8 formed in a polyimide layer 10. Layer 6 is impregnated with a solution saturated with potassium chloride (KCl). Layer 10 comprises a recess at one of its ends to house a membrane 12 made of porous hydrophilic polymer material. A portion of membrane 12 is covered with electrolyte layer 6. Porous membrane 12 is impregnated with electrolyte KCl.

During the operation of this electrode, one end of membrane 12 is dipped into an aqueous solution 14 forming the cell electrolyte. A proton transfer between internal electrolyte 6 and electrolyte 14 of the cell is then possible via membrane 12.

The use of a porous polymer membrane, as in patent U.S. Pat. No. 6,419,809, does not fulfill the conditions of impermeability to ions. Indeed, the membrane is crossed by water and ions, given its small thickness. The composition of the internal electrolyte progressively changes, which results in the failure of the reference electrode. The lifetime of this type of electrode ranges between one week and three months.

It is envisaged, in article “A solid-state pH sensor based on a Nation-coated iridium oxide indicator electrode and a polymer-based silver chloride reference electrode” (P. J. Kinlen et al., Sens. Actuators, B 22, pp.13-25, 1994), to use a protective membrane made of Nation (DuPont trademark) as a separating membrane. Such a proton exchange membrane improves the impermeability to ions of the junction, thus enabling to maintain a constant reference potential.

Nafion membranes are used in a similar way in PEMFCs (“Proton Exchange Membrane Fuel Cell”) between two catalytic layers, where the oxidation and reduction reactions take place. The membrane separates the two cell compartments and only leaves way to protons.

In the miniature reference electrode of the above-mentioned article, the Nafion membrane is only efficient for a short period, given its low thickness. The use of a larger Nafion thickness is limited by the miniaturization effort and a high cost of the material.

The miniature reference electrode may be incorporated in batteries for controlling the state of health or for controlling charge and discharge cycles. Given that batteries have a lifetime capable of reaching several years, it is desired to obtain a reference electrode which remains reliable over as long a period.

### SUMMARY OF THE INVENTION

A need therefore exists to provide, at a lower cost, a miniature reference electrode having a long lifetime.

This need tends to be satisfied by providing a reference electrode comprising a reference electrolyte and a proton exchange membrane arranged to Is separate the reference electrolyte from a medium external to the electrode, the proton exchange membrane comprising acid-doped polyaniline particles distributed in a bonding polymer material.

A method for forming a miniature reference electrode is also provided.

The method comprises the steps of forming a mixture of an acid-doped polyaniline based powder and of a liquid polymerizable material, depositing a layer of the mixture on a reference electrolyte layer and polymerizing the mixture.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1, previously described, shows an exploded view of a miniature reference electrode according to prior art,

FIG. 2 schematically represents a cell for testing a proton exchange membrane used in a miniature reference electrode according to the present invention,

FIG. 3 represents the impedance moduli of an electrode according to the present invention and of several conventional electrodes, as functions of frequency,

FIG. 4 shows a cross-section view of an embodiment of an electrode according to the present invention,

FIGS. 5 and 6 respectively show in cross-section view and in simplified top view a half-electrode according to an alternative embodiment, and

FIG. 7 schematically represents an assembly of two half electrodes according to FIGS. 5 and 6.

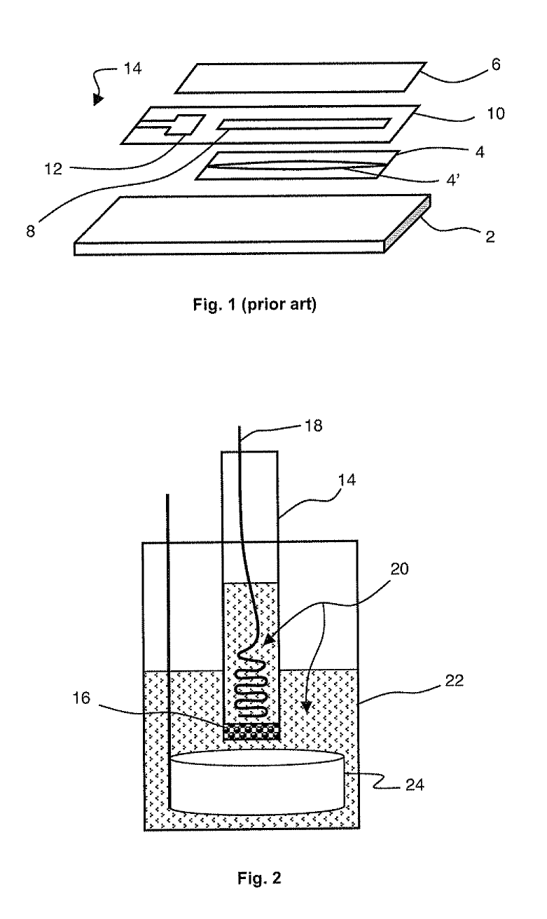

### DESCRIPTION OF A PREFERRED EMBODIMENT OF THE INVENTION

The inventors have observed that the reliability of a reference electrode may be considerably improved by means of a polyaniline-based (PANI) separating membrane, in acid-doped form. Acid-doped polyaniline means a salt resulting from the reaction of polyaniline with an acid. This form of polyaniline has a good proton conductivity. It is further perfectly adapted to the conditions of use in a reference electrode. On the one hand, it is not soluble in water, alkaline or acid solutions, and most organic solvents. On the other hand, it resists oxidation and reduction reactions, especially with atmospheric oxygen. Hereinafter, terms “PANI” or “polyaniline” will be used to designate acid-doped polyaniline.

Polyaniline is an electrically-conductive polymer which may be used as an electrode. However, its use as a proton exchange membrane in PEMFCs is not possible since this would cause a short-circuit between the cell electrodes. It has thus not been envisaged, up to now, to use polyaniline in a reference electrode as a membrane.

Preferably, polyaniline is in the form of particles and the membrane comprises a polymer matrix having the particles dispersed therein. The ratio of the polyaniline mass to the polymer mass is advantageously comprised between 1 and 2. The membrane thus obtained is then compact and non-porous, contrary to conventional membranes.

The porosity to water and to sulfate ions, which corresponds to the permeability of the membrane, may be assessed as follows: a tube containing a solution of 5 mol/L of sulfuric acid (5 M H₂SO₄) and closed by a PANI-based membrane is dipped into a beaker containing de-ionized water. The pH of the water is measured a few minutes after having dipped the membrane into the water, and then after one week. The pH remains constant, which indicates that the PANI-based membrane is impermeable to to sulfate ions (SO₄²⁻, HSO₄⁻).

The proton conductivity is the parameter characterizing the ability of the membrane leave way to protons. It is directly dependent on the electric resistance of the membrane. Further, the membrane is generally the most resistive element of the reference electrode and a high electrode resistance results in an error on potential measurements. This resistance is thus desired to be minimized.

In prior art porous membranes impregnated with electrolyte, the resistance is related to the porosity rate. Thus, there is a compromise between the resistance and the impermeability to ions. Indeed, the higher the porosity of the membrane is, the more ions are capable of crossing it.

The PANI-based membrane being non-porous, it is provided to assess its impedance in order to verify its ability to be a part of a reference electrode.

FIG. 2 shows an experimental electrochemical cell enabling to determine the impedance of a PANI-based membrane. The cell comprises a tube 14 having a diameter of approximately 8 mm. One end of tube 14 is tightly closed by a membrane 16 formed of epoxy resin and of PANI (ratio 1:1), with a thickness of approximately 1 mm. A spiral-shaped lead wire 18 is arranged inside of the tube and partly immersed in an electrolyte 20 of 5 M H₂SO₄. Tube 14 is then dipped into the same electrolyte 20, so that membrane 16 is totally immersed. Lead wire 18 then forms a work electrode. The cell is completed by a platinum back-electrode 24 dipped into electrolyte 20. In such a configuration, membrane 16 is the most resistive element of the cell.

The impedance of membrane 16 may be determined by measuring the impedance of the electrochemical cell of FIG. 2. Indeed, said impedances are substantially identical, given that the membrane is in contact with electrolyte 20 on both sides and in the immediate neighborhood of the conductive portions. The ohmic drop due to electrolyte H₂SO₄ is thus negligible. The method used is impedance spectroscopy over a frequency range from 0.1 Hz to 65 kHz by means of a sinusoidal signal having amplitude ranging between 5 and 10 mV.

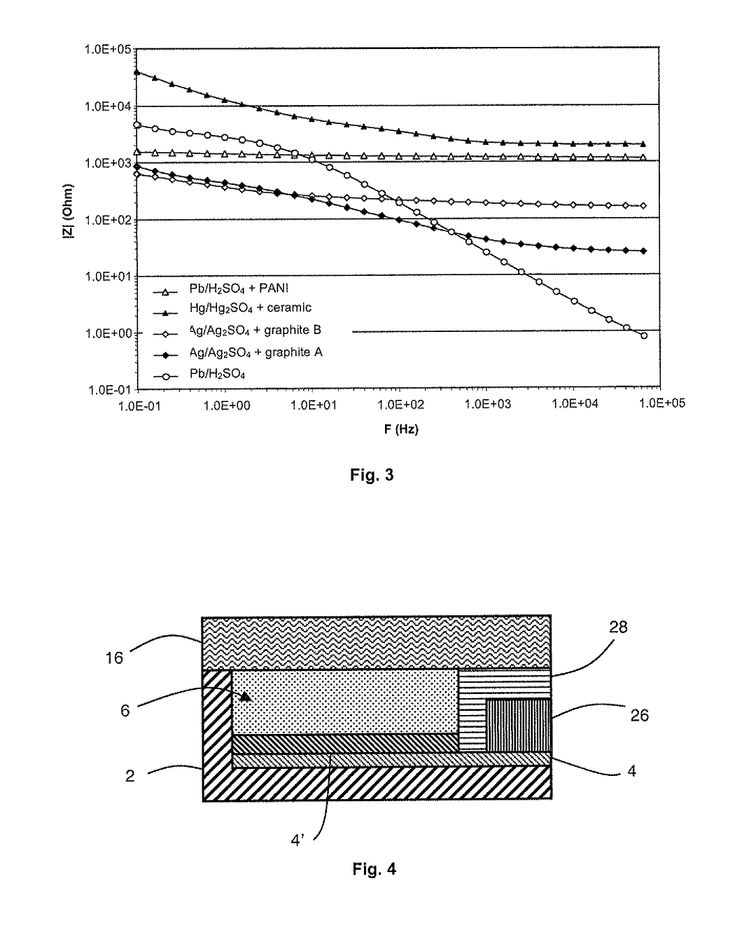

FIG. 3 shows the impedance (expressed by its modulus) of the cell of to FIG. 2 (Pb/H₂SO₄ PANI). Conventional electrodes using porous membranes have been measured as a comparison, and especially Ag/Ag₂SO₄ and Hg/Hg₂SO₄ electrodes with graphite or ceramic membranes. Two types of graphite are used: a high-porosity graphite (A) and a low-porosity graphite (B).

The ohmic resistance of the PANT membrane, visible at the top of the frequency spectrum (>10 kHz), reaches values comprised between those of conventional electrodes Hg/Hg₂SO₄ and Ag/Ag₂SO₄. The PANI-based membrane thus achieves similar performances in terms of resistance. It can thus be used to form an accurate reference electrode.

The impedance of a cell having no membrane can also be seen in FIG. 3. The ohmic resistance of this cell is lower than that of the cell shown in FIG. 2, by from two to three orders of magnitude. This shows that membrane contributes to most of the cell impedance. Actually, the impedance measured in this case corresponds to the resistance of electrolyte H₂SO₄, to the parasitic resistances, and to the contact resistances.

The realization of a PANI-based membrane may raise a number of difficulties. Acid-doped polyaniline is generally obtained by electrochemical synthesis. It thus appears in the form of an electrodeposition on electrodes. The obtained material is hard and friable, which makes it difficult to use in the form of a membrane.

In the context of the formation of the reference electrode, polyaniline is also electrochemically synthesized. A layer of approximately 1.5 mm of PANI may for example be obtained on graphite electrodes dipped into a bath comprising an aniline sulfate solution (0.15 mol/L) and a sulfuric acid electrolyte (0.25 mol/L), by applying a current of about 1 mA.cm⁻² for a time period of 300 h.

The deposition thus formed is ground in the form of a powder. The powder particles have a variable size. The PANI powder is then mixed with a liquid polymerizable material to form a paste. Then, the paste is deposited in the form of a layer. Finally, the paste is polymerized, preferably by thermal processing at a temperature comprised between 60° C. and 80° C. or by ultraviolet irradiation. A dense, non-porous structure due to the polymerization method is then obtained.

The polymerizable material is preferably a pre-polymer activated by an acid or by a radical. It is also preferable for the material to be stable in acid electrolytes and to preserve the proton conductivity of PANI. Phenol-furfural is based pre-polymers, phenol-formaldehyde based pre-polymers, methyl methacrylate based pre-polymers, or acid-hardened epoxy resin based pre-polymers fulfill these criteria. Further, with such pre-polymers, the paste is perfectly adapted to low-cost printing technologies, especially screen printing.

To optimize the performance of the reference electrolyte, the electrochemical synthesis of polyaniline may be adapted to the desired type of electrode. A precursor (the aniline source) and an electrolyte are preferably selected according to the redox couple and to the nature of the internal electrolyte. For example, if the electrode is of type Ag/Ag₂SO₄/H₂SO₄, the precursor may be aniline sulfate and the electrolyte may be H₂SO₄.

In other words, the precursor contains an ion identical to one of the ions of the internal electrolyte and the synthesis electrolyte is of same nature as the internal electrolyte. Thus, the polyaniline is doped with the same ion as one of the ions of the internal electrolyte. In the present example, said ion is the sulfate ion, also present in the salt of the redox couple. Exchanges between anions at the interface between the PANI and the electrolyte are thus minimized, such exchanges usually creating an adverse interface potential.

FIG. 4 represents an embodiment of a miniature reference electrode provided with a PANI-based membrane. The electrode is formed on a glass or silicon substrate 2 covered with a passivation layer, having a thickness of approximately 1 mm. The layers forming the electrode are preferably deposited by screen printing.

A cavity having a depth of approximately 300 μm is first etched in substrate 2. A silver layer 4, having a thickness of approximately 30 μm, is then deposited at the bottom of the cavity. A silver sulfate layer 4′ having a thickness of approximately 60 μm is deposited on a portion of layer 4. An electric contact pad 26, for example made of copper, is also formed on silver layer 4, at one end of the electrode. A layer 6, for example made of glass microfibers, is then deposited on the entire layer 4′. Its thickness is approximately 210 μm. An electrically-insulating layer 28, preferably made of polymer, covers pad 26 and a portion of layer 4 located between the pad and layer 4′. A lateral surface of pad 26 corresponding to the edge of the electrode is exposed to the ambient environment. After the hardening of layer 28, an electrolytic solution (H₂SO₄) is inserted into layer 6 to form the electrolyte layer. Such an insertion may be performed by inkjet printing or by means of a microsyringe.

Substrate 2, electrolyte layer 6, and insulating layer 28 form a surface, preferably planar, having a PANI-based paste layer deposited thereon, so as to totally seal electrolyte 6. The paste is then polymerized to form membrane 16. The thickness of membrane 16 is preferably comprised between 0.5 and 1 mm. Short-circuits between pad 26 and layer 6 and between pad 26 and membrane 16 are avoided by insulating layer 28.

In the example of FIG. 4, membrane 16 comprises, by mass, twice as much PANI as polymer.

To finalize the construction of the reference electrode, a metal current collector is attached to contact pad 26, for example by welding. The reference electrode is further covered with a protective envelope, made of plastic matter for example. The envelope preferably covers the entire electrode except for a portion of membrane 16, arranged above layer 4′.

Such a reference electrode has a large contact surface area between the electrolyte of the cell and membrane 16, which decreases the electric resistance thereof.

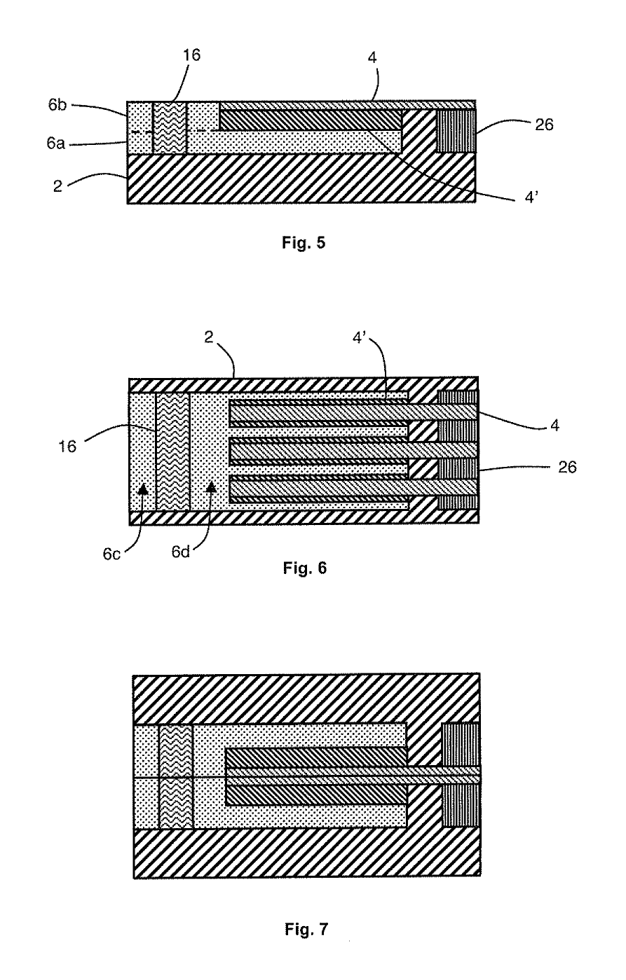

FIGS. 5 to 7 illustrate an alternative embodiment of a reference electrode, formed of two identical halves which are bonded afterwards. FIGS. 5 and 6 respectively show a half-electrode in cross-section view and in simplified top view, while FIG. 7 shows the reference electrode once assembled.

Each half-electrode comprises a substrate 2 having two distinct cavities approximately 300-μm deep formed therein, each cavity opening out on one end of the electrode. One cavity (to the right in FIGS. 5 and 6) is filled with contact pad 26. A first layer 6a of glass microfibers, silver sulfate layer 4′ (50-100-μm thickness), and silver layer 4 (20-50-μm thickness) are successively deposited in the other cavity (to the left). Layer 4 covers layer 4′, pad 26, and the substrate portion located therebetween. Finally, a second layer 6b of is glass microfibers and membrane 16 (thickness of 300 μm) are deposited at the end opposite to pad 26, preferably up to the level of layer 4.

The membrane polymerization, as well as the filling of microfiber layers 6a and 6b by the liquid electrolyte, is performed as previously described.

FIG. 6 shows that the layer of glass microfibers is preferably divided into two portions 6c and 6d separated by membrane 16. Portion 6c, at the end of the electrode, protects membrane 16 from a direct contact with the other cell electrodes. Further, as shown in FIG. 6, layers 4 and 4′ may be arranged in the form of strips laterally spaced apart in portion 6d by approximately 50 μm. This eases the step of filling of portion 6d with the internal electrolyte.

In FIG. 7, after having inserted the electrolyte into layer 6, the two half-electrodes are tightly bonded by their layers 4, for example, by gluing. A current collector and a protective envelope are attached on the electrode, as described in relation with FIG. 4. The unprotected portion of the electrode corresponds to portion 6c of the electrolyte layer, which is in contact with the cell electrolyte.

The above-described method for forming the reference electrode may comprise steps common with other electrode forming methods. A reference electrode, a work electrode, and a back-electrode may for example be formed simultaneously on a same substrate. A complete electrochemical device, for example, a chemical detector, may thus be formed by these simple and inexpensive techniques.

Numerous variants and modifications of the reference electrode described herein will occur to those skilled in the art. Especially, the embodiment has been described in relation with the silver/silver sulfate couple and electrolyte H₂SO₄. However, the present invention is not limited to a specific type of electrodes. It may also be envisaged to use couples Ag/AgCl, Ag/AgBr, Ag/Agl and electrolytes HCl, HBr, Hl . . . Similarly, other porous (solid) materials, used as a container for the internal electrolyte (liquid), may be used, especially glass in the form of microbeads made porous by a chemical etching and behaving as a reservoir.

1. A reference electrode comprising:
a reference electrolyte, and
a proton exchange membrane arranged to separate the reference electrolyte from a medium external to the electrode,
wherein the proton exchange membrane comprises acid-doped polyaniline particles distributed in a bonding polymer material.

2. The reference electrode according to claim 1, wherein the ratio of the polyaniline mass to the mass of bonding polymer material is comprised between 1 and 2.

3. The reference electrode according to claim 1, wherein the polyaniline is doped with an ion identical to one of the ions of the reference electrolyte.

4. A method for forming a reference electrode comprising the steps of:
forming a mixture of an acid-doped polyaniline based powder and of a liquid polymerizable material,
depositing a layer of the mixture on a reference electrolyte layer, and
polymerizing the mixture.

5. The method according to claim 4, comprising, before forming the mixture, the steps of:
electrochemically synthesizing acid-doped polyaniline,
grinding the acid-doped polyaniline to form a powder.

6. The method according to claim 5, wherein the electrochemical synthesis of acid-doped polyaniline is performed by means of a precursor containing an ion identical to one of the ions of the reference electrolyte.

7. The method according to claim 5, wherein the electrochemical synthesis of acid-doped polyaniline is performed by means of an electrolyte identical to the reference electrolyte.

8. The method according to claim 4, wherein the polymerizable material is a phenol-furfural based pre-polymer, a phenol-formaldehyde based pre-polymer, a methyl methacrylate based pre-polymer, or an acid-hardened epoxy resin based pre-polymer.
